(19) United States
(12) Patent Application Publication
(10) Pub. No.: US 2008/0248224 A1
(43) Pub. Date: Oct. 9, 2008

(54) (METH)ACRYLIC COATED CERAMIC ARTICLE

(76) Inventors: Vy Hong Duong, Hamilton, OH (US); Kareem Kaleem, Loveland, OH (US); Robert B. Hodek, Sarver, PA (US); Terence J. Hart, Pittsburgh, PA (US)

Correspondence Address: PPG INDUSTRIES INC;INTELLECTUAL PROPERTY DEPT, ONE PPG PLACE, PITTSBURGH, PA, 15272, US

(21) Appl. No.: 11/695,853

(22) Filed: Apr. 3, 2007

(51) Int. Cl. C03C 17/32; C08G 63/02; B65D 85/00

(52) U.S. Cl. 428/34.7; 106/287.19; 528/272; 528/306; 206/524.3; 215/400

(57) ABSTRACT

A coated ceramic article wherein the coating comprises a crosslinked (meth)acrylic resin.

### FIELD OF THE INVENTION

The present invention is directed to a coated ceramic article, wherein the coating comprises a crosslinked (meth)acrylic resin.

### BACKGROUND OF THE INVENTION

It is often desired to put one or more various coatings on ceramic articles for decorative and/or protective purposes. For example, if the ceramic article is a food container, a coating can provide both protection to the food as well as the container. Ceramic articles can become scratched and/or abraded. Such scratching and/or abrasion reduces the strength of the ceramic material. The “burst strength” of a ceramic article, such as a glass bottle or other container, refers to the amount of pressure that will cause the ceramic article to shatter. The burst strength of a ceramic article is particularly relevant for ceramic articles that are reused, such as refillable bottles. Refillable bottles undergo significant handling. For example, the bottles are typically pressurized and filled once, and distributed to consumers, who return the bottles for reuse. The returned bottles are typically subjected to a caustic wash, in which they are exposed to heated, highly basic pH solutions for several minutes. The washed and rinsed bottles are then subjected once again to a pressurization and filling step. The caustic wash, as well as various scratches and abrasions that the bottle may undergo during all of the handling stages, contribute to the lowering of the burst strength of the bottle. It is therefore desired to enhance the burst strength of a ceramic article.

### SUMMARY OF THE INVENTION

The present invention is directed to a coated ceramic article, wherein the coating comprises a crosslinked (meth)acrylic resin.

### DETAILED DESCRIPTION OF THE INVENTION

The present invention is directed to a coated ceramic article, wherein the coating comprises a crosslinked (meth)acrylic resin. Any (meth)acrylic resin can be used according to the present invention. Typically, the resin is a polymeric material, so the (meth)acrylic resin is sometimes referred to herein as a (meth)acrylic polymer, or like terms. The (meth)acrylic resin polymeric can include those polymers formed by interpolymerizing an alpha, beta-ethylenically unsaturated acid, such as the carboxylic acid monomers including, without limitation, (meth)acrylic acid, ethacrylic acid, maleic acid, crotonic acid, propyl(meth)acrylic acid, isopropyl(meth)acrylic acid, mesaconic acid, citraconic acid, sorbic acid, fumaric acid, and itaconic acid or any homologs thereof with a (meth)acrylic acid ester. “(Meth)acrylic” and like terms will be understood as encompassing both methacrylic and the corresponding acrylic. In general, (meth)acrylic polymers that are useful have the major portion of a (meth)acrylate ester of a C₁ to C₈ alcohol and a minor portion of a (meth)acrylate ester of C₁ to C₈ alcohol. Typically useful (meth)acrylate esters include but are not limited to ethyl(meth)acrylate, propyl(meth)acrylate, isopropyl(meth)acrylate, butyl(meth)acrylate, isobutyl(meth)acrylate, secondary butyl(meth)acrylate, hexyl(meth)acrylate, 2-ethylhexyl(meth)acrylate, octyl(meth)acrylate, methyl(meth)acrylate, tertiary butyl(meth)acrylate, hydroxyethyl methacrylate (HEMA), (meth)acrylic acid ((M)AA), methyl acrylate, ethyl acrylate, butyl acrylate, acrylic acid, and/or mixtures thereof.

Acrylic polymers are particularly suitable and can comprise any number of acrylic or other ethylenically unsaturated monomers. For example, any combination of the following monomers could be used: (meth)acrylic acids, butyl(meth)acrylate, N-butoxy methyl(meth)acrylamide, allyl(meth)acrylate, styrene, hydroxyalkyl(meth)acrylates, (meth)acrylamides, N,N-dimethyl(meth)acrylamide, N-i-propyl(meth)acrylamide, butyl(meth)acrylamide, maleic acid, maleic anhydride, itaconic acid, vinyl acetic acid, allyl acetic acid, allyl alcohol, (meth)acrylonitriles, vinyl toluene, vinyl xylene, vinyl sulfonic acid, allyl sulfonic acid, vinyl phosphonic acid, vinyl acetate, 2-(meth)acrylamido-2-methylpropane sulfonic acid, styrene sulfonic acid, hydroxyalkyl acrylates, vinyls, vinylidene fluorides, vinyl esters, carboxylethyl(meth)acrylic acid, sulfoalkyl(meth)acrylates, allyloxy-2-hydroxypropane sulfonic acid and (meth)acrylamido hydroxypropyl sulfonic acid.

In accordance with certain embodiments of the present invention, the acrylic polymers are polymerized using a free radical initiator, as is known to those skilled in the art. Useful free radical initiators include, without limitation, redox initiators, peroxide type catalysts, such as, for example, cumene hydroperoxide, or azo compounds, such as, for example, azobisisobutyronitrile. These initiators can be used singly or in a suitable mixture to achieve desired acrylic resins.

The (meth)acrylic resins used in this invention may contain 0.1 to 20 percent by weight of a polymerized alpha, beta-ethylenically unsaturated carboxylic acid unit, such as those described above. (Meth)acrylic acids are particularly suitable since these acids form particularly high quality polymers. The percentage of acid is adjusted to give the desired acid number in the (meth)acrylic polymer. Usually the acid number of the (meth)acrylic polymer is adjusted so that it is about 30 to 100 on resin solids. The number average molecular weight of the acrylic polymers can range from 1,000 to 40,000, such as 10,000 to 30,000, based upon GPC results.

The (meth)acrylic polymers used in this invention may also contain pendant hydroxyl groups that are attained by copolymerizing hydroxyalkyl(meth)acrylates with the (meth)acrylic esters. The pendant hydroxyl groups provide sites for subsequent curing with a crosslinker, such as an aminoplast or blocked isocyanate. In certain embodiments, 5-15 percent by weight of the (meth)acrylic polymer used in this invention is of a hydroxyalkyl(meth)acrylate ester. Typically useful hydroxyalkyl(meth)acrylates contain 1-8 carbon atoms in the alkyl group and are, for example, hydroxyethyl(meth)acrylate, hydroxypropyl(meth)acrylate, hydroxybutyl(meth)acrylate, hydroxyhexyl(meth)acrylate and hydroxyoctyl(meth)acrylate.

The acrylic monomer may also include a monomer that renders the polymer water soluble, such as (meth)acrylamide, isobutoxymethyl(meth)acrylamide, and butoxyl(meth)acrylamide or the like. Suitable copolymerizable nonionic monomers include nonionic ethylenically unsaturated monomers, such as vinyl aromatic compounds and alkyl esters of ethylenically unsaturated carboxylic acids. Included among such monomers are, without limitation, lower alkyl(meth)acrylates, styrene, alkyl-substituted styrenes, vinyl acetate and (meth)acrylonitrile. Alternatively, the (meth)acrylic polymer can be made water-soluble by the incorporation of hydrophilic groups into the polymer. Hydrophilic groups can include ionic salt groups, including anionic salt groups such as carboxylic and/or sulfonic acid salt groups. “Water-soluble” means the resins can be dispersed or stabilized in water.

The (meth)acrylic resin can be crosslinked with a suitable crosslinker, which reacts with the active hydrogens on the acrylic resin. Suitable crosslinkers include, for example, aminoplast resins and/or blocked isocyanates. Aminoplast resins, which are common curing agents for the (meth)acrylic resins described above, are the condensation products of amine or amides with aldehydes. Examples of suitable amine or amides include melamine, benzoguanamine, urea and similar compounds. Generally, the aldehyde employed is formaldehyde, although other aldehydes can be used. The condensation product can contain methylol groups or similar alkylol groups depending on the particular aldehyde employed. These methylol groups can be etherified by reaction with an alcohol. Various alcohols employed include monohydric alcohols containing from 1 to 4 carbon atoms such as methanol, ethanol, isopropanol, butanol, and the like. Aminoplast resins are commercially available from Cyanamid in their CYMEL line. In certain embodiments, the aminoplast is a methylated formaldehyde melamine, such as CYMEL 303.

The (meth)acrylic resin can be reacted with the crosslinker according to any procedures known in the art. Upon reaction of the (meth)acrylic resin and crosslinker, the reaction product comprising the anionic acid moieties can be neutralized with an amine. Suitable amines include diethylethanolamine trimethylamine, ammonia, monoethanol amine, diethyl amine, monoisopropanol amine, morpholine, dimethyl ethanol amine, triethyl amine, diethanol amine, diisopropanol amine, triethanol amine, tributyl amine, triisopropanol amine. Any percent of the acid on the acrylic/aminoplast reaction product can be neutralized with an amine, such as 50% to 80%, substantially 100% neutralization, or even over-neutralized, such as up to 150% neutralization.

The ratio of (meth)acrylic resin to crosslinker can be from 90:10 to 60:40 based on total solids with 100% neutralization.

The coating is most typically a water borne coating, comprising 30 to 50, such as 40 to 50% solids, of which 60 to 95, such as 80 to 90%, comprises the (meth)acrylic resin as described above. In ceramic and/or glass forming operations, where open flame may be used, water borne coatings are typically desired. “Water borne” means that the nonsolid portion of the coating is 50% or more water. In some embodiments, the nonsolid portion of the coating may be at least 80% water, such as at least 95% water. In certain applications some solvent may be used even in water borne coatings. Suitable solvents include lower alcohols, glycol ethers, aromatics and ketones. In certain other applications, however, solvent borne coatings may be desired. “Solvent borne” means that the nonsolid portion of the coating is 50% or more organic solvent.

The present coatings can further comprise one or more additives that are standard in the art such as one or more of surfactants, wetting agents, catalysts, film-build additives, flatting agents, defoamers, UV absorbers, hindered amine light stabilizers (“HALS”), adhesion promoters, flow additives, lubricants, colorants and the like. Suitable UV absorbers include those available from Ciba-Geigy in its TINUVIN line, such as TINUVIN 1130, TINUVIN 328 and TINUVIN 327. Suitable HALS include TINUVIN 123 and TINUVIN 292. Suitable adhesion promoters include epoxy silane adhesion promoters, such as A187, commercially available from Union Carbide, Z6040 epoxy functional silane from Dow-Corning, and also epoxy silane adhesion promoters from GE. Suitable lubricants include nylon beads, such as those commercially available from Atofina in its ORGASOL line, waxes, such as those commercially available from BARECO, Michelman, Daniels Products, and Micropowders. In certain embodiments, such as if the coated ceramic article will be exposed to sunlight or other UV light, it is particularly suitable to use both a UV absorber and a HALS to minimize delamination and improve caustic wash resistance. Byk 300 silicone resin from Byk Chemie, and exempt mineral spirit defoamer (aliphatic hydrocarbons) available from Exxon, Shell Chemical Co., and Texaco are also suitable additives.

The coatings used according to the present invention can also include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, pthalo green or blue, iron oxide and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference. In general, the colorant can be present in the coating composition in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

As noted above, the present invention is directed to coated ceramic articles. As used herein, the term “ceramic” refers to a wide range of substrates generally characterized as brittle, heat resistant, and/or formed from one or more non-metallic minerals, including but not limited to pottery, earthenware, clay, whiteware, refractories, porcelain, glass ceramic and glass. The ceramic articles of the present invention can be glazed or unglazed, and can be in any shape, size and/or configuration. The term “article” refers to any ceramic product such as food containers, prescription lenses, imaging lenses, optical fibers, and automobile and building windows, for example. A “food container” is any container in which food and/or beverage is served, stored and/or shipped. In certain embodiments, the food container is a glass article, such as a glass jar, glassware including but not limited to drinking or wine glasses, glass jugs, or glass dinnerware. In a particular embodiment, the ceramic article is a glass bottle. The ceramic article according to the present invention can be clear or opaque, and can be colored or not colored.

The manufacture of glass bottles will be well known to those skilled in that art. In certain embodiments, the glass may be strengthened in some manner, such as by annealing the glass and/or chemically strengthening the glass. Suitable methods for annealing and/or chemically strengthening the glass are discussed in a number of U.S. patents and applications.

As will be further understood by those skilled in the art of bottle making, bottles may be subjected to one or more of various coatings, such as a hot end coating and/or a cold end coating. The hot end coating, as the name implies, is applied to the bottle while it is still hot (i.e. 400-630° C.). A typical hot end coating is a tin oxide coating. The cold end coating is typically applied to the bottle after it has cooled significantly (i.e. to a temperature of about 80-150° C.). Typical cold end coatings can include, for example, wax emulsions, stearic acid, or silane coatings.

The coatings used according to the present invention can be used, if desired, with a hot end coating and/or a cold end coating, or any various other coatings. In certain embodiments, however, the use of a fatty acid containing coating in conjunction with the (meth)acrylic coating is specifically excluded. For example, a primer layer can be applied to the bottle prior to the application of the coating described herein. A suitable primer is described in U.S. Pat. No. 5,776,548, the contents of which are hereby incorporated by reference. In certain embodiments, a silane adhesion promoter is added to the coating, rather than using a primer.

The coatings of the present invention can also be used in combination with one or more decorative coatings. Particularly suitable as a decorative coating include UV curable inks. Other suitable decorative coatings include those comprising a reactive organic resin, a reactive wax, and a blocked isocyanate, such as those described in U.S. Pat. No. 6,214,414 B1, incorporated by reference herein, and pigmented or nonpigmented compositions comprising an organic binder and a rigid organic and/or inorganic particle, such as particles that are rigid at or below a first temperature and that soften at a second temperature at or below the temperature at which the binder cures. Such coatings are described in U.S. Patent Publication Nos. 2004/0058144, 2005/0025891 and 2005/0069714, all of which are incorporated by reference herein. In these embodiments, the decorative coating would be applied to the bottle first, followed by any of the coatings described above.

The (meth)acrylic coatings of the present invention can be applied by any means known in the art such as by spraying or dipping. The viscosity of the coating can be adjusted as necessary by adding water or organic solvent to achieve the desired viscosity. Any spraying or dipping means known in the art can be used. The coating of the present invention is typically applied to bottles that are unheated, that is, bottles that are at a temperature of 20° C. to 40° C. Any film build can be used according to the present invention, such as 0.01 to 2.0 mils dry film thickness (“DFT”); a particularly suitable DFT is 0.6 mils to 2 mils such as 0.7 to 1.5 mils. In certain embodiments, the coating has a DFT of less than 50 microns (i.e. about 2 mils), such as less than 20 microns (i.e. about 0.8 mils). It will be appreciated by those skilled in the art that the coating used according to the present invention is a thermoset coating, and not a plastic, rubber, or elastomeric-polymeric coating or film. This will be apparent from the chemical description of the coating.

The coated ceramic articles of the present invention find particular application as refillable glass bottles. As noted above, these bottles undergo significant handling and exposure to caustic for often as many as 25 cycles. In certain embodiments, the glass bottle is a light weight glass bottle. In certain embodiments, the coated ceramic articles show caustic resistance and/or resistance to scratching and/or abrasion. Coated ceramic articles according to the present invention, particularly coated glass bottles, show enhanced burst strength as compared to similar ceramic articles that are uncoated. For example, a pristine glass bottle having little to no abrasion will typically have a burst strength of 450 to 500 psi. The coated bottle of the present invention can have a burst strength of 200 psi or greater after 20 caustic wash cycles. A similar bottle that is uncoated may exhibit only a few cycles prior to bursting at the same or lower burst pressure. Burst pressure can be measured using equipment available from American Glass Research, according to ASTM C 147-86 (2005) (Internal Pressure Resistance (Hydrolytic):Glass).

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Therefore, while reference is made herein, including the claims, to “an” acrylic, “an” aminoplast and “an” amine, one or more of any of these things or any of the other components described herein can be used.

### EXAMPLE

The following example is intended to illustrate the invention, and should not be construed as limiting the invention in any way. A coating according to the present invention was prepared using the following ingredients:

| | | Formula | | Percent |
|---|---|---|---|---|
| | % | Weight | NVW | Solids |
| Description | NVM | (gms) | (gms) | (%) |
| High solids acrylic resin* | 71.60 | 102.750 | 73.57 | 73.6% |
| CYMEL 303 LF (Cyanamid) | 100.00 | 18.400 | 18.40 | 18.4% |
| N,N-diethylethanolamine (DEEA) | | 15.010 | | |
| Deionized water | | 26.320 | | |
| BYK-300 silicone resin solution | 50.00 | 2.06 | 1.03 | 1.0% |
| (Byk Chemie) | | | | |
| Silane adhesion promoter Z-6040 | 99.00 | 3.030 | 3.00 | 3.0% |
| (Dow Corning) | | | | |
| TINUVIN 1130, UV absorber, | 100.00 | 3.000 | 3.00 | 3.0% |
| (Ciba-Geigy) | | | | |
| TINUVIN 292, Hindered amine | 100.00 | 1.000 | 1.00 | 1.0% |
| light stabilizer (Ciba Geigy) | | | | |
| Exempt mineral spirits | | 9.000 | | |
| Deionized water | | 300.000 | | |
| Totals | | 480.570 | 100.0 | 100% |

*Acrylic resin containing the following base resin components in parts by weight:
Butyl Acrylate - 55%
HEMA - 5%
Styrene - 25%
Methacrylic acid - 15%

To 102.75 grams of acrylic resin were added to 18.4 grams of methylated melamine (CYMEL 303LF). The agitator was turned on high speed until the acrylic and melamine were adequately mixed. 15.0 grams of DEEA were added with mild stirring and the mixture stirred for 10 minutes. The rest of components were then added sequentially as shown in the table under stirring agitation. When all the components were completely added, the finished formula was mixed for another 20 minutes. The coating gave about 21% theoretical solids.

The coating was applied to 200 ml bottles by using spray and dip application techniques. The bottles had a hot end coating of tin oxide applied first, to aid with adhesion. Adhesion of the coating was excellent, and passed a 30+ soaking of 7 minutes at 70° C. in caustic cleaner having 2.5% NaOH. The average film weight was about 600 to 1000 milligrams per 200 ml bottle and uniformly applied over the entire surface area. The coating was allowed to flash for several minutes at room temperature before being baked in the conventional oven. The bake schedule for the coating was 45 minutes at 350° F. (177° C.). The resulting coated bottles had excellent appearance with little or no yellowing.

Therefore we claim:

1. A coated ceramic article, wherein the coating comprises a crosslinked (meth)acrylic resin.

2. The article of claim 1, wherein the (meth)acrylic resin comprises butyl acrylate, hydroxyethyl methacrylate, styrene and/or methacrylic acid.

3. The article of claim 1, wherein the crosslinker comprises an aminoplast.

4. The article of claim 3, wherein the aminoplast comprises a methylated formaldehyde melamine.

5. The article of claim 1, wherein the crosslinked (meth)acrylic resin is at least partially neutralized with an amine.

6. The article of claim 5, wherein the amine comprises diethylethanolamine.

7. The article of claim 6, wherein neutralization is substantially 100%.

8. The article of claim 1, wherein the ceramic article is a glass bottle.

9. The glass bottle of claim 8, wherein the glass bottle is annealed.

10. The glass bottle of claim 8, wherein the glass bottle is chemically strengthened prior to coating.

11. The glass bottle of claim 10, wherein the glass bottle is annealed.

12. The glass bottle of claim 8, wherein the glass bottle has a hot end coating and/or cold end coating applied thereto.

13. The glass bottle of claim 12, wherein the hot end coating comprises tin oxide.

14. The glass bottle of claim 12, wherein the cold end coating comprises stearic acid.

15. The coated ceramic article of claim 1, wherein the ceramic article is a food container.

16. The coated food container of claim 15, wherein the coating is water borne.

17. The glass bottle of claim 8, wherein the coating is water borne.

18. The ceramic article of claim 1, wherein the coating has a dry film thickness of less than 50 microns.

19. The glass bottle of claim 8, wherein the coating has dry film thickness of less than 50 microns.

20. The ceramic article of claim 1, wherein a decorative coating is also applied to at least a portion of the ceramic article.

21. The ceramic article of claim 20, wherein the decorative coating comprises an organic binder and a plurality of organic and/or inorganic particles that are rigid at or below a first temperature and that soften at or above a second temperature at which the binder cures.

22. The glass bottle of claim 8, wherein a decorative coating is also applied to at least a portion of the ceramic article.

23. The glass bottle of claim 22, wherein the decorative coating comprises an organic binder and a plurality of organic and/or inorganic particles that are rigid at or below a first temperature and that soften at or above a second temperature at which the binder cures.
